(19) United States
(12) Patent Application Publication
(10) Pub. No.: US 2025/0165480 A1
(43) Pub. Date: May 22, 2025

(54) SYSTEMS AND METHODS FOR RETRIEVAL AUGMENTED GENERATION

(71) Applicant: Elsevier Inc., New York, NY (US)

(72) Inventors: Adrian Raudaschl, London (GB); Erik Schwartz, London (GB); Henry Cleland, London (GB); Kehan Zhang, Amsterdam (NL)

(73) Assignee: Elsevier Inc., New York, NY (US)

(21) Appl. No.: 18/954,236

(22) Filed: Nov. 20, 2024

Related U.S. Application Data
(60) Provisional application No. 63/600,925, filed on Nov. 20, 2023.

(51) Int. Cl. G06F 16/2457; G06F 16/242

(52) U.S. Cl. CPC G06F 16/24578; G06F 16/243

(57) ABSTRACT

Systems and methods herein provide a processor; and a non-transitory, processor readable storage medium communicatively coupled to the processor. The non-transitory, processor readable storage medium may include one or more instructions stored thereon that, when executed, cause the processor to: input one or more queries into a large language model; generate, based on the one or more queries, a plurality of natural language queries, wherein each of the plurality of natural language queries are distinct queries and associated with the one or more queries; perform vector searches for the one or more queries and plurality of natural language queries; compile the plurality of natural language queries into a search result based on the vector searches; and generate a summary based on the search result.

### CROSS-REFERENCE TO RELATED APPLICATIONS

The application claims priority to U.S. Provisional Patent Application Ser. No. 63/600,925, filed Nov. 20, 2023, entitled, “SYSTEMS AND METHODS FOR RETRIEVAL AUGMENTED GENERATION,” the entirety of which is incorporated by reference herein.

### FIELD

The present disclosure relates to retrieval augmented generation, and more particularly, to systems and methods for retrieval augmented generation.

### BACKGROUND

Retrieval Augmented Generation (RAG) systems are known for being associated with search and information retrieval technologies using generative artificial intelligence, various challenges and deficiencies exist.

### SUMMARY

In one aspect, a system may include a processor. The system may include a non-transitory, processor readable storage medium communicatively coupled to the processor. The non-transitory, processor readable storage medium may include one or more instructions stored thereon that, when executed, cause the processor to input one or more queries into a large language model. The non-transitory, processor readable storage medium may include one or more instructions stored thereon that, when executed, cause the processor to generate, based on the one or more queries, a plurality of natural language queries. Each of the plurality of natural language queries are distinct queries and associated with the one or more queries. The non-transitory, processor readable storage medium may include one or more instructions stored thereon that, when executed, cause the processor to perform vector searches for the one or more queries and plurality of natural language queries. The non-transitory, processor readable storage medium may include one or more instructions stored thereon that, when executed, cause the processor to compile the plurality of natural language queries into a search result based on the vector searches. The non-transitory, processor readable storage medium may include one or more instructions stored thereon that, when executed, cause the processor to generate a summary based on the search result.

In another aspect, a method to be performed by a processor of a computing device is provided. The method may include inputting one or more queries into a large language model. The method may include generating, based on the one or more queries, a plurality of natural language queries. Each of the plurality of natural language queries may be distinct queries and associated with the one or more queries. The method may include performing vector searches for the one or more queries and plurality of natural language queries. The method may include compiling the plurality of natural language queries into a search result based on the vector searches. The method may include generating a summary based on the search result.

In another aspect, a non-transitory, computer-readable medium including instructions that, when executed by at least one processor, cause the at least one processor to perform one or more operations including inputting one or more queries into a large language model. The instructions that, when executed by the at least one processor, cause the at least one processor to perform one or more operations including generating, based on the one or more queries, a plurality of natural language queries. Each of the plurality of natural language queries may be distinct queries and associated with the one or more queries. The instructions that, when executed by the at least one processor, cause the at least one processor to perform one or more operations including performing vector searches for the one or more queries and plurality of natural language queries. The instructions that, when executed by the at least one processor, cause the at least one processor to perform one or more operations including compiling the plurality of natural language queries into a search result based on the vector searches. The instructions that, when executed by the at least one processor, cause the at least one processor to perform one or more operations including generating a summary based on the search result.

### BRIEF DESCRIPTION OF THE DRAWINGS

FIG. 1 depicts a schematic RAG fusion model system in an example environment, according to one or more embodiments shown and described herein;

FIG. 2 depicts a schematic diagram of a workflow process of multi-query generation of the RAG fusion model of FIG. 1, according to one or more embodiments shown and described herein; and

FIG. 3 depicts a schematic diagram of a reciprocal rank fusion (RRF) positional re-ranking process of the RAG fusion model of FIG. 1, according to one or more embodiments shown and described herein.

### DETAILED DESCRIPTION

While RAG can provide advantages, such as vector search fusion (such as the integration of vector search capabilities with generative models, which can enable the generation of richer, more context-aware outputs from large language models (LLMs); reduced hallucination (such as diminishing the LLM's propensity for hallucination, making the generated text more grounded in data); and personal and professional utility (such as versatility in enhancing productivity and content quality while being based on a trustworthy data source), various challenges and deficiencies exist.

In certain aspects, limitations of RAG systems include constraints with current search technologies. RAG is limited by the same things limiting retrieval-based lexical and vector search technologies. Moreover, while users can write, they are not great at writing what they desire into search systems, and can include typographical errors, vague queries, or limit vocabulary. This can lead to missing the vast reservoir of information that lies beyond the obvious top search results. While RAG can assist, it has not entirely solved this problem. Still further, conventional search paradigms linearly map queries to answers, lacking the depth to understand the multi-dimensional nature of human queries. Such linear models fail to capture the nuances and contexts of more complex user inquiries, resulting in less relevant results.

In view of the above, a need exists for systems and methods that address RAG deficiencies by not only retrieving what is asked but also grasps the nuance behind queries without needing ever-more advanced large language models that unnecessarily incur taxing computing processing and resources.

The systems and methods disclosed herein provide techniques for tackling constraints inherent in RAG by generating a plurality of user queries and re-ranking the results, and utilizing reciprocal rank fusion and custom vector score weighting for comprehensive and accurate results. The systems and methods disclosed herein are, in certain aspects, configured to bridge the gap between what users explicitly ask and what they intend to ask, getting closer to uncovering the transformative knowledge that can remain hidden. In certain aspects, the systems and methods disclosed herein include a programming language, including but not limited to Python; a dedicated vector search database configured to steer document retrieval; and a large language model configured to craft the text. By way of example, and in certain aspects, the systems and methods disclosed herein may be referred to as a RAG fusion model 120.

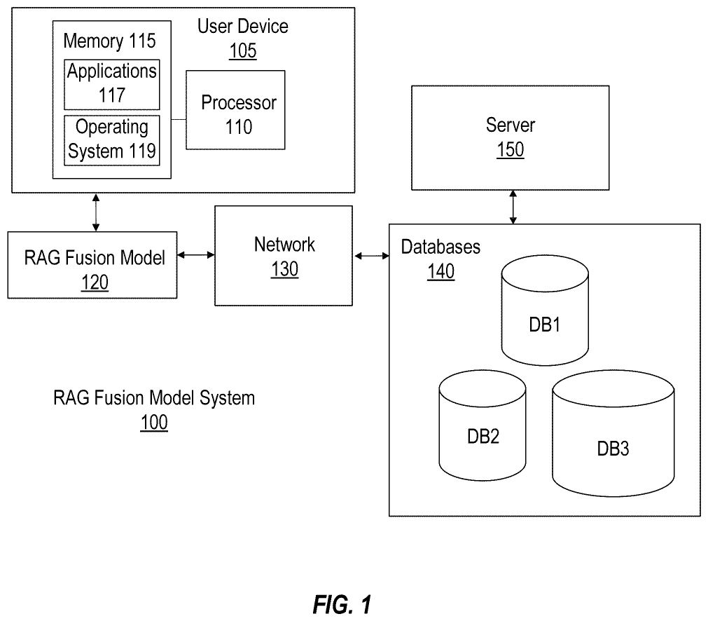

FIG. 1 depicts a RAG fusion model system 100 in an environment including a user device 105, a model 120, a network 130, one or more databases 140, and a server 150. Although single instances of the constituent components of the environment including the RAG fusion model system 100 are depicted, any number of constituent components may be included.

The user device 105 may include any computing device (e.g., a personal computer, a tablet computer, a cellular telephone, a smartphone or other smart device, a stateless device, or the like), may be used by a user to interact, including but not limited to submitting any number of commands, queries, and/or instructions via a communication interface, with the RAG fusion model system 100 or any constituent component of the environment.

In certain embodiments, the user device 105 may include a processor 110, such as a central processing unit (CPU), which may be the central processing unit that is configured to perform calculations and logic operations to execute one or more programs. The processor 110, alone or in conjunction with the other components, may be an illustrative processing device, computing device, processor, or combinations thereof, including, for example, a multi-core processor, a microcontroller, a field-programmable gate array (FPGA), or an application-specific integrated circuit (ASIC). The processor 110 may include any processing component configured to receive and execute instructions (such as from the non-transitory, processor readable storage medium 115, including but not limited to memory). In some embodiments, the processor 110 may include a plurality of processing devices.

The user device 105 may include the non-transitory, processor readable storage medium 115, or the memory, which may contain one or more data repositories for storing data that is received and/or generated. The non-transitory, processor readable storage medium 115 may be any physical storage medium, including, but not limited to, a hard disk drive (HDD), memory (e.g., read-only memory (ROM), programmable read-only memory (PROM), random access memory (RAM), double data rate (DDR) RAM, flash memory, and/or the like), removable storage, a configuration file (e.g., text) and/or the like. While the non-transitory, processor readable storage medium 115 is depicted as a local device, it should be understood that the non-transitory, processor readable storage medium 115 may be a remote storage device, such as, for example, a server computing device, cloud-based storage device, or the like.

As will be described herein, one or more memories 115 may include an operating system 117 and one or more applications 119. Any number of applications 119 may be included. In some examples, at least one of the applications include an algorithm, as further described below. For example, the processor 110 may be configured to perform operations of the algorithm, such as the RAG fusion model 120. Although single instances of the constituent components of the operating system 117 and the application 119 are depicted in memory 115, any number of operating systems and applications may be included. Each of the memories 115 may comprise, without limitation, any number of non-transitory computer-readable mediums.

The network 130 may be in data communication with any of the components of the environment including the RAG fusion model system 100. The network 130 may be one or more of a wireless network, a wired network or any combination of wireless network and wired network and may be configured to connect any of the components of the RAG fusion model system 100. For example, network 130 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 130 may include, without limitation, telephone lines, fiber optics, IEEE Ethernet 802.3, a wide area network, a wireless personal area network, a LAN, or a global network such as the Internet. In addition, network 130 may support an Internet network, a wireless communication network, a cellular network, or the like, or any combination thereof. Network 130 may further include one network, or any number of the exemplary types of networks mentioned above, operating as a stand-alone network or in cooperation with each other. Network 130 may utilize one or more protocols of one or more network elements to which they are communicatively coupled. Network 130 may translate to or from other protocols to one or more protocols of network devices. Although network 130 is depicted as a single network, it should be appreciated that according to one or more examples, network 130 may include a plurality of interconnected networks, such as, for example, the Internet, a service provider's network, a cable television network, corporate networks, such as credit card association networks, and home networks.

The one or more databases 140, including but not limited to DB1, DB2, DB3, DBN, where “N” may refer to any integer number, may be configured to store and transmit any number of input data, including respective input data, as further described below. All input data may be stored in a single database. In other examples, one or more databases DB1, DB2, DB3 may store different types of input data. The one or more databases DB1, DB2, DB3 may be in data communication with the RAG fusion model system 100, server 150, and the user device 105 via the network 130. By way of example and without limitation, the one or more databases 140 may include a dedicated vector search database, including but not limited to Elasticsearch or Pinecone, configured to steer document retrieval.

The server 150 may be configured to retrieve any data from the one or more databases 140 DB1, DB2, DB3. The server 150, in certain embodiments, may be configured as a central system, server or platform to control and call various data at different times to execute a plurality of workflow actions. The server 150 is configured to connect to any of the constituent components of the RAG fusion model system 100. For example, the server 100 is configured to receive one or more requests from the user device 105 via network 130. Based on the one or more requests from the user device 105, the server 150 is configured to retrieve the requested data from one or more databases 150, such as DB1, DB2, DB3. Based on receipt of the requested data from the one or more databases 150, the server 150 is configured to transmit the received data to the user device 105, the received data being responsive to one or more requests, and includes without limitation the input data.

In certain embodiments, it is understood that any of the constituent components of the RAG fusion model system 100, including but not limited to the one or more databases 140 and/or the server 150, may be configured to perform any of the operations any number of the commands, queries, and/or instructions by the user device 105. Further, any of the constituent components of the RAG fusion model system 100, including but not limited to the one or more databases 140 and/or the server 150, may include the processor 110 and/or the memory 115.

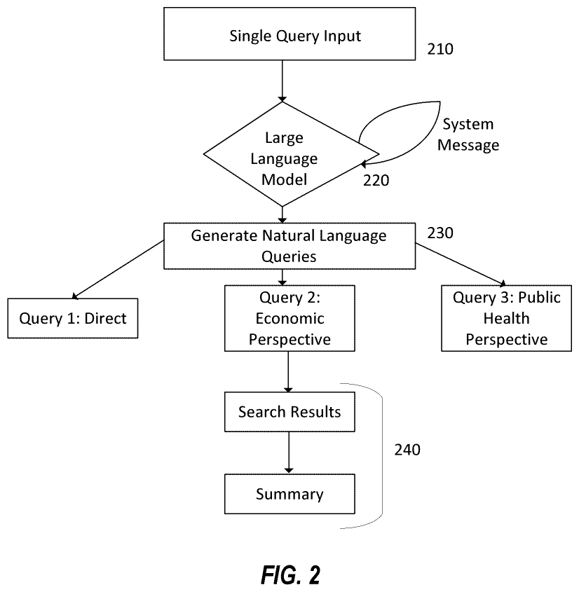

FIG. 2 depicts a diagram of a workflow process 200 of multi-query generation of the RAG fusion model 120. As previously explained, the processor 110 may be configured to execute the RAG fusion model 120. FIG. 2 may reference and incorporate any of the aspects described above with respect to FIG. 1.

The RAG fusion model 120 leverages prompt engineering and natural language models to broaden search horizons and enhance result quality. The use of prompt engineering by the processor 110 may be utilized to generate a plurality of queries that are not only similar to an original query but also offer different angles or perspectives.

At step 210, the process 200 may include inputting one or more queries. For example, a single or an original query may be inputted via the user device 105. It is understood that the query may be input by constituent components of the system 100 other than the user device 105. In certain embodiments, the leveraging of prompt engineering may be associated with inputting the query. Further, the input of the single query is not limited to such, as more than one query, such as two or more queries, is within the scope of input.

At step 220, the process 200 may include calling a large language model, including but not limited to ChatGPT. For example, the calling may be performed by the RAG fusion model 120. The single query may be input to the large language model, which may be expected to execute a specific instruction set, referred to as a system message, to guide the large language model. For example, the system message instructs the model to act as an interactive artificial intelligent (AI) assistant. While a specific instruction set or a system message is disclosed, it is understood that any number of specific instruction sets or system messages may be executed.

At step 230, the process 200 may include the large language model being configured to output a plurality of natural language queries. For example, the RAG fusion model 120 may be configured to, via the large language model, generate the plurality of natural language queries. In certain embodiments, the model may be configured to generate the plurality of queries based on the original query. Moreover, the plurality of queries that are generated are not merely random variations of the original query. Rather, the plurality of queries are carefully generated to offer different perspectives on the original query. For example, to the extent that the original query was about “the impact of climate change”, the generated plurality of queries may include angles, such as “economic consequences of climate change,” “climate change and public health”, etc. Accordingly, at least one query of the plurality of queries may include an economic perspective associated with the original query, and another query of the plurality of queries may include a public health perspective associated with the original query. This approach ensures that the search process, undertaken by the RAG fusion model 120, considers a broader range of information, thereby increasing the quality and depth of the generated summary.

At step 240, the process 200 may include the RAG fusion model 120 being configured to generate a summary based on a search result. For example, the RAG fusion model 120 may be configured to compile each of the plurality of queries into the search result.

Still further, unlike RAG, the RAG fusion model 120 differentiates itself with, in certain embodiments, query generation and a re-ranking of the results. In certain aspects, the RAG fusion model 120 may be configured to translate a user query into similar yet distinct queries via the large language model. In certain embodiments, the RAG fusion model 120 is configured to perform vector searches for the original query and its newly generated query siblings, which may refer to the plurality of queries that are generated. The RAG fusion model 120 is configured to utilize intelligent ranking by aggregating and refining all results using reciprocal rank fusion. In certain aspects, the RAG fusion model 120 is configured to pair cherry-picked results with new queries, guiding the LLM to a crafted output that considers all the queries and the re-ranked list of results. In conventional systems, users often input a single query to find information. While this approach is straightforward, there exist limitations. For example, a single query may not capture the full scope of what the user is interested in, or it may be too narrow to yield comprehensive results. This is where generating multiple user queries from different perspectives comes into play, as specifically generated by the RAG fusion model 120 via the LLM.

Equation 1 depicts a reciprocal rank fusion (RRF) algorithm. RRF may refer to a technique for combining the ranks of multiple search result lists to produce a single, unified ranking. RRF may yield better results than any individual system and better results than standard re-ranking methods.

$$RRFscore ( d ϵ D ) = {\sum }_{r ε R} \frac{1}{k + r ( d )} \qquad ( Equation 1 )$$

In Equation 1, “d” may refer to a document or a document type, “R” may refer to a set of rankers or a set of retrievers, “r (d)” may refer to a rank of the document (d), and “k” may refer to a constant, such as a predetermined value.

By combining ranks from different queries via the RRF algorithm, such as the different plurality of queries that are generated, the likelihood is increased that the most relevant documents may appear at the top of a final list. RRF is particularly effective because it does not rely on the absolute scores assigned by the search engine but rather on the relative ranks, making it preferable for combining results from the generated plurality of queries that might have different scales or distributions of scores. In certain embodiments, RRF may be used to blend lexical and vector results. While this technique may help make up for the lack of specificity of vector search when looking up specific terms like acronyms, the results are unimpressive, which tend to be more of a patchwork of multiple result sets as the same results rarely come up for the same query for lexical and vector search.

In certain aspects, the RRF algorithm may be analogized as a person who insists on getting opinions from everyone prior to rendering a decision. In this case, it is helpful, in which case the more opinions obtained, the likelihood of the increased accuracy of the result.

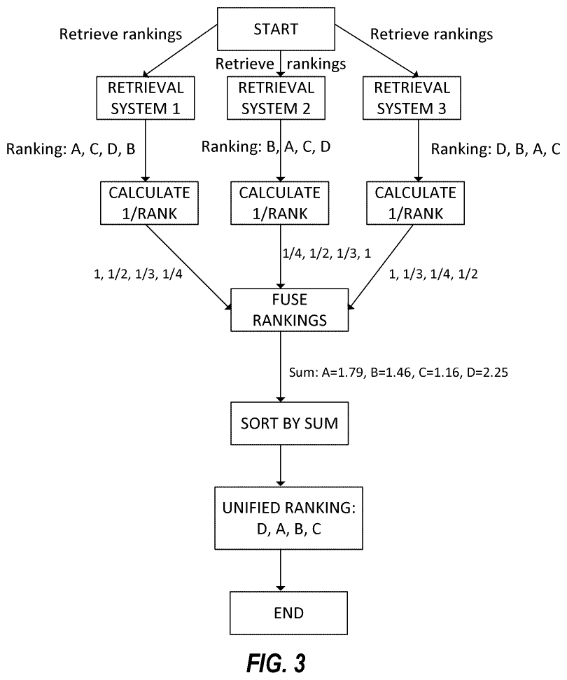

FIG. 3 depicts a reciprocal rank fusion (RRF) positional re-ranking process 300. In certain embodiments, the RRF positional re-ranking process 300 may be executed by the processor 110. By way of example, the RAG fusion model 120 may include any and all of the operations performed by the RRF positional re-ranking process 300. FIG. 3 may reference and incorporate any of the aspects described above with respect to FIG. 1 and FIG. 2.

The RRF positional re-ranking process 300 may be configured to take a dictionary of search results, where each key is a query, and the corresponding value is a list of document identifiers ranked by their relevance to that query. The RRF positional re-ranking process 300 may be configured to calculate a new score for each document based on its ranks in the different lists. More particularly, the RRF positional re-ranking process 300 may be configured to then sort them to create a final re-ranked list. After calculating the fused scores, the RRF positional re-ranking process 300 may be configured to sort the documents in a predetermined order, such as a descending order, of these scores to obtain the final re-ranked list, which is then returned.

One of the challenges in using a plurality of queries is the potential dilution of the original intent of the user. To mitigate this, the RAG fusion model 120 may be instructed, via the RRF positional re-ranking process 300, to preferentially give more weight to the original query in the prompt engineering. In this manner, user intent is preserved. The re-ranked documents and all queries may be fed into an LLM prompt to produce generative output, such as asking for a response or a summary. By layering these technologies and techniques, the RAG fusion model 120 provides a powerful, nuanced approach to text generation. It leverages the best of search technology and generative AI to produce high-quality, reliable outputs.

In certain aspects, the RAG fusion model 120, as disclosed herein, provides several advantages: Superior Source Material Quality; Enhanced User Intent Alignment; Structured, Insightful Outputs; Auto-Correcting User Queries; Navigating Complex Queries; and Serendipity in Search. Each of these are separately described below.

Regarding Superior Source Material Quality, the depth of a user search is not merely enhanced but rather amplified. The re-ranked list of relevant documents means that it is not merely scraping the surface of information but diving into an ocean of perspectives. The structured output may be easier to read and feels intuitively trustworthy, which is crucial in a world skeptical of AI-generated content.

Regarding Enhanced User Intent Alignment, at its core, the RAG fusion model 120 is configured to be an empathic AI that brings to light what users are striving to express but perhaps cannot articulate. Leveraging a plurality of queries strategy captures a multifaceted representation of the informational needs of the user, thus delivering holistic outputs and resonating with user intent.

Regarding Structured, Insightful Outputs, by drawing from a diverse set of sources, the RAG fusion model 120 crafts well-organized and insightful answers, anticipating follow-up questions and preemptively addressing them.

Regarding Auto-Correcting User Queries, the RAG fusion model 120 not only interprets but also refines user queries. Through the generation of multiple query variations, the RAG fusion model 120 performs implicit spelling and grammar checks, thereby enhancing search result accuracy.

Regarding Navigating Complex Queries, human language often falters when expressing intricate or specialized thoughts. The RAG fusion model 120 acts as a linguistic catalyst, generating variations that may incorporate the jargon or terminologies required for more focused and relevant search results. It can also take longer, more complex queries and break them down into smaller, manageable chunks for the vector search.

Regarding Serendipity in Search, one may consider the “unknown unknowns”, information you do not know you need until you encounter it. The RAG fusion model 120 allows for this serendipitous discovery. By employing a broader query spectrum, the RAG fusion model 120 engenders the likelihood of unearthing information that, while not explicitly sought, becomes a eureka moment for the user. This sets the RAG fusion model 120 apart from other traditional search models.

There may be challenges with the RAG fusion model 120. For example, this may include the risk of being overly verbose. The depth of the RAG fusion model 120 may lead to a deluge of information. Outputs may be detailed to the point of being overwhelming.

This challenge may also include balancing the context window. The inclusion of multi-query input and a diversified document set may stress the context window of the large language model. For models with tight context constraints, this may lead to less coherent or even truncated outputs.

With the RAG fusion model 120, the power to manipulate user queries to improve results may feel as if it is crossing into some kind of moral grey zone. Balancing the improved search results with the integrity of user intent is important, and it is recognized there are some considerations when implementing this solution, such as ethical concerns and user experience.

Regarding ethical concerns, user autonomy and transparency may be considered. For user autonomy, the manipulation of user queries may deviate from the original intent. It is important to consider how much control is being ceded to AI and at what cost. For transparency, it is not just about better results; users should be aware if and how their queries are adjusted. This transparency is important to maintain trust and respect user intent.

Regarding User Experience (UX) Enhancements, consider preserving original query and visibility of process. For preservation of the original query, the RAG fusion model 120 may be configured to prioritize the initial user query, ensuring its importance in the generative process. This may act as a safeguard against misinterpretations.

For visibility of process, displaying generated queries alongside final results may provide users with a transparent look at the scope and depth of the search. It may aid in building trust and understanding.

Regarding UX/UI Implementation, consideration may be given to user control, such as offering users an option to toggle the RAG fusion model 120, allowing the user(s) the choice between manual control and enhanced AI assistance, and guidance & clarity, such as a tooltip or brief explanation(s) about the RAG fusion model 120 workings that may help set clear user expectations.

Further aspects of the invention are provided by the subject matter of the following clauses.

A system, including: a processor; and a non-transitory, processor readable storage medium communicatively coupled to the processor, the non-transitory, processor readable storage medium including one or more instructions stored thereon that, when executed, cause the processor to: input one or more queries into a large language model; generate, based on the one or more queries, a plurality of natural language queries, wherein each of the plurality of natural language queries are distinct queries and associated with the one or more queries; perform vector searches for the one or more queries and plurality of natural language queries; compile the plurality of natural language queries into a search result based on the vector searches; and generate a summary based on the search result.

The system of any preceding clause, wherein the one or more instructions further cause the processor to instruct the large language model to operate as an interactive artificial intelligent chat assistant.

The system of any preceding clause, wherein the one or more instructions further cause the processor to: retrieve rankings via one or more respective retrieval systems; and re-rank each of the one or more retrieved rankings.

The system of the preceding clause, wherein the one or more instructions further cause the processor to fuse each of the one or more re-ranked retrieved rankings.

The system of the preceding clause, wherein the one or more instructions further cause the processor to sort the one or more fused rankings by sum to generate a unified ranking.

The system of any preceding clause, wherein the one or more instructions further cause the processor to calculate a new score for each document based on a respective rank in one or more lists.

The system of the preceding clause, wherein the one or more instructions further cause the processor to: sort each document with a respective new score to create a re-ranked list; and output each document in a predetermined order.

A method, the method including: inputting one or more queries into a large language model; generating, based on the one or more queries, a plurality of natural language queries, wherein each of the plurality of natural language queries are distinct queries and associated with the one or more queries; performing vector searches for the one or more queries and plurality of natural language queries; compiling the plurality of natural language queries into a search result based on the vector searches; and generating a summary based on the search result.

The method of any preceding clause, further comprising instructing the large language model to operate as an interactive artificial intelligent chat assistant.

The method of any preceding clause, further comprising: retrieving rankings via one or more respective retrieval systems; and re-ranking each of the one or more retrieved rankings.

The method of the preceding clause, further comprising fuse each of the one or more re-ranked retrieved rankings.

The method of the preceding clause, further comprising sorting the one or more fused rankings by sum to generate a unified ranking.

The method of any preceding clause, further comprising calculating a new score for each document based on a respective rank in one or more lists.

The method of any preceding clause, further comprising: sorting each document with a respective new score to create a re-ranked list; and outputting each document in a predetermined order.

A non-transitory, computer-readable medium comprising instructions that, when executed by at least one processor, cause the at least one processor to perform one or more operations comprising: inputting one or more queries into a large language model; generating, based on the one or more queries, a plurality of natural language queries, wherein each of the plurality of natural language queries are distinct queries and associated with the one or more queries; performing vector searches for the one or more queries and plurality of natural language queries; compiling the plurality of natural language queries into a search result based on the vector searches; and generating a summary based on the search result.

The non-transitory, computer-readable medium of any preceding clause, comprising instructions that further cause the at least one processor to instruct the large language model to operate as an interactive artificial intelligent chat assistant.

The non-transitory, computer-readable medium of any preceding clause, comprising instructions that further cause the at least one processor to: retrieve rankings via one or more respective retrieval systems; and re-rank each of the one or more retrieved rankings.

The non-transitory, computer-readable medium of the preceding clause, comprising instructions that further cause the at least one processor to fuse each of the one or more re-ranked retrieved rankings.

The non-transitory, computer-readable medium of any preceding clause, comprising instructions that further cause the at least one processor to sort the one or more fused rankings by sum to generate a unified ranking.

The non-transitory, computer-readable medium of any preceding clause, comprising instructions that further cause the at least one processor to: calculate a new score for each document based on a respective rank in one or more lists; sort each document with a respective new score to create a re-ranked list; and output each document in a predetermined order.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system, comprising:
a processor; and
a non-transitory, processor readable storage medium communicatively coupled to the processor, the non-transitory, processor readable storage medium comprising one or more instructions stored thereon that, when executed, cause the processor to:
input one or more queries into a large language model;
generate, based on the one or more queries, a plurality of natural language queries, wherein each of the plurality of natural language queries are distinct queries and associated with the one or more queries;
perform vector searches for the one or more queries and plurality of natural language queries;
compile the plurality of natural language queries into a search result based on the vector searches; and
generate a summary based on the search result.

2. The system of claim 1, wherein the one or more instructions further cause the processor to instruct the large language model to operate as an interactive artificial intelligent chat assistant.

3. The system of claim 1, wherein the one or more instructions further cause the processor to:
retrieve rankings via one or more respective retrieval systems; and
re-rank each of the one or more retrieved rankings.

4. The system of claim 3, wherein the one or more instructions further cause the processor to fuse each of the one or more re-ranked retrieved rankings.

5. The system of claim 4, wherein the one or more instructions further cause the processor to sort the one or more fused rankings by sum to generate a unified ranking.

6. The system of claim 1, wherein the one or more instructions further cause the processor to calculate a new score for each document based on a respective rank in one or more lists.

7. The system of claim 6, wherein the one or more instructions further cause the processor to:
sort each document with a respective new score to create a re-ranked list; and
output each document in a predetermined order.

8. A method, comprising:
inputting one or more queries into a large language model;
generating, based on the one or more queries, a plurality of natural language queries, wherein each of the plurality of natural language queries are distinct queries and associated with the one or more queries;
performing vector searches for the one or more queries and plurality of natural language queries;
compiling the plurality of natural language queries into a search result based on the vector searches; and
generating a summary based on the search result.

9. The method of claim 8, further comprising instructing the large language model to operate as an interactive artificial intelligent chat assistant.

10. The method of claim 8, further comprising:
retrieving rankings via one or more respective retrieval systems; and
re-ranking each of the one or more retrieved rankings.

11. The method of claim 10, further comprising fusing each of the one or more re-ranked retrieved rankings.

12. The method of claim 11, further comprising sorting the one or more fused rankings by sum to generate a unified ranking.

13. The method of claim 8, further comprising calculating a new score for each document based on a respective rank in one or more lists.

14. The method of claim 8, further comprising:
sorting each document with a respective new score to create a re-ranked list; and
outputting each document in a predetermined order.

15. A non-transitory, computer-readable medium comprising instructions that, when executed by at least one processor, cause the at least one processor to perform one or more operations comprising:
inputting one or more queries into a large language model;
generating, based on the one or more queries, a plurality of natural language queries, wherein each of the plurality of natural language queries are distinct queries and associated with the one or more queries;
performing vector searches for the one or more queries and plurality of natural language queries;
compiling the plurality of natural language queries into a search result based on the vector searches; and
generating a summary based on the search result.

16. The non-transitory, computer-readable medium of claim 15, comprising instructions that further cause the at least one processor to instruct the large language model to operate as an interactive artificial intelligent chat assistant.

17. The non-transitory, computer-readable medium of claim 15, comprising instructions that further cause the at least one processor to:
retrieve rankings via one or more respective retrieval systems; and
re-rank each of the one or more retrieved rankings.

18. The non-transitory, computer-readable medium of claim 17, comprising instructions that further cause the at least one processor to fuse each of the one or more re-ranked retrieved rankings.

19. The non-transitory, computer-readable medium of claim 15, comprising instructions that further cause the at least one processor to sort the one or more fused rankings by sum to generate a unified ranking.

20. The non-transitory, computer-readable medium of claim 15, comprising instructions that further cause the at least one processor to:
calculate a new score for each document based on a respective rank in one or more lists;
sort each document with a respective new score to create a re-ranked list; and
output each document in a predetermined order.
